(19) United States
(12) Patent Application Publication
(10) Pub. No.: US 2002/0126818 A1
(43) Pub. Date: Sep. 12, 2002

(54) Advanced internet call session manager

(76) Inventors: Yigang Cai, Naperville, IL (US); Shiyan Hua, Wheaton, IL (US)

Correspondence Address: Gregory P. Gadson, Esq.,, 19375 Amber Way, Indianapolis, IN, 46060, US

(21) Appl. No.: 09/800,952

(22) Filed: Mar. 7, 2001

(51) Int. Cl. H04M 3/42

(52) U.S. Cl. 379/215.01; 379/900

(57) ABSTRACT

An Advanced Internet Call Session Manager service system allows a service subscriber to screen telephone calls while connected to the Internet with improved efficiency. In the preferred embodiment, only for those callers who enter a Personal Identification Number established by the subscriber, and only if other calling ID and screening criteria established by the subscriber are met, will an incoming call (while the subscriber is connected to the Internet) be treated as an Internet Call Waiting call (which the subscriber may choose to connect to or ignore). No other calls disturb the subscriber's usage of the Internet. That is, the subscriber does not receive any pop-up messages or audio reminders. A log (including any voice messages) is kept of all incoming calls—whether or not they were presented as Internet Call Waiting calls—for later review by the subscriber.

### BACKGROUND OF THE INVENTION

1. Field of the Invention

The present invention generally relates to networks for providing telephone services. More particularly, the present invention relates to efficiently managing incoming telephone calls to a telephone line currently connected to an Internet Service Provider during an Internet call session.

2. Background

Public switched telephone networks (PSTNs) have many important uses, including the handling of typical telephone calls. Additionally, PSTNs are being increasingly used to connect computers to wide area networks (WANs) such as the “Internet.”

Many telephone customers use a single telephone line for both receiving and placing typical “voice” calls, and for connecting a microcomputer to the Internet. With standard telephone service, however, it is not possible for a customer to receive telephone calls on a line while the line is being used to connect a computer via an Internet Service Provider (ISP) to the Internet. Because of relatively inexpensive ISP monthly fees, many customers spend considerable time connected to the Internet, leaving large periods of time in which no telephone calls can be received on the line in use.

To address this problem, the prior art has proposed an Internet Call Waiting (ICW) service, which announces (on a screen, speakers, or both) the identity of a calling party to a subscriber while the subscriber's computer is connected to the Internet. The subscriber can then choose to either connect a call of interest (thereby temporarily disconnecting from the Internet), or ignore it.

For most subscribers engaged in an Internet call session, many distracting pop-up menus and the like associated with Internet Call Waiting telephone calls can be both distracting and annoying. Yet, it is desirable—but not provided for by the prior art—to be able to pre-screen calls from parties of the subscriber's choosing, while not having the annoyance of pop-up menus and the like, for all other telephone calls.

### SUMMARY OF THE INVENTION

In view of the aforementioned problem and deficiencies of the prior art, the present invention provides, in a Public Switched Telephone Network (PSTN), the method at least including the steps of connecting a subscriber's telephone line to an Internet Service Provider (ISP), while the subscriber's telephone line is connected to the ISP, disabling an Internet Call Waiting (ICW) server, and when a telephone call is placed to the subscriber's telephone line, ascertaining whether a calling party has input a subscriber-defined access code. The method also at least includes the steps of connecting the calling party to the ICW server and enabling it, if the calling party has input the access code, not connecting the calling party to the ICW server if the calling party has not input the access code, and via the enabled ICW server, displaying caller identification information to the subscriber when a call has been connected to the ICW server to allow the subscriber to cause the call to be connected, or ignore the call.

### BRIEF DESCRIPTION OF THE DRAWING FIGURES

Features and advantages of the present invention will become apparent to those skilled in the art from the description below, with reference to the following drawing figures, in which:

FIG. 1 is a schematic block diagram of the present-inventive Advanced Internet Call Session Manager (AICSM);

FIG. 2 is a variation of the AICSM in FIG. 1, using an Intelligent Network in place of the Local Switch; and

FIG. 3 is a flowchart/algorithm detailing the call flow of the present-inventive AICSM.

### DESCRIPTION OF THE PREFERRED EMBODIMENTS

1. Basic Advanced Internet Call Session Manager Components

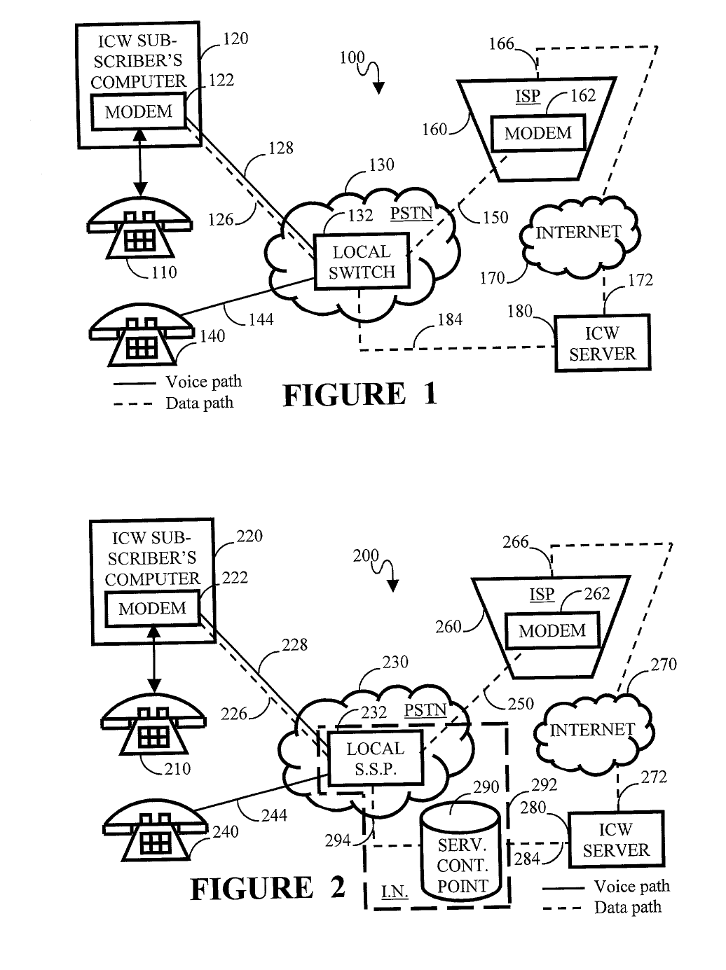

The basic components of the Advanced Internet Call Session Manager (AICSM) of the present invention are illustrated in FIGS. 1 and 2. The AICSM 100 in FIG. 1 is implemented using a modified Local Switch 132 for carrying out, in addition to its well-known functions, the functions of the present invention. An alternate embodiment 200 of the present-inventive AICSM is shown in FIG. 2. Functionally equivalent to the AICSM 100, the AICSM 200 uses an Intelligent Network 292 to carry out the unique features of the present invention. In FIGS. 1 and 2, the solid connection lines between components represent voice paths, while the dashed connection lines between components represent data paths.

Returning to FIG. 1, the telephone line (represented by the icon 110) of a subscriber to the present-inventive AICSM service is connected to a computer or computer system 120 via a MODEM 122. As is labeled on the computer icon 120, the subscriber also has Internet Call Waiting service as is now known in the art. The computer 120 contains any software needed at the user end to implement Internet Call Waiting Service.

When a subscriber desires to connect to the Internet with the present-inventive AICSM service enabled, the computer 120, via the MODEM 122 connects (via a data path 126) the Local Switch 132 of a Public Switched Telephone Network 130, specifying as the called party number, that of an Internet Service Provider (ISP) 160. In the preferred embodiment, the protocol used between the computer 120 and the Local Switch 132, is PPP (“Point-to-Point”). Those skilled in the art will appreciate that other suitable protocols may be used without departing from the scope of the present invention. Along with providing the telephone number of the ISP 160, the computer 120 also indicates that the AICSM service is enabled.

As in the prior art, the ISP 160 (connected to the Local Switch via a data path 150 and a MODEM 162) connects the subscriber's telephone line to the Internet 170 via a data path 166. An Internet Call Waiting (ICW) Server 180 (connected via data paths 172 and 184) controls the operation of call waiting messages which are sent to a subscriber when the subscriber receives telephone messages while the subscriber's telephone line is connected to the Internet, whereupon the subscriber can choose to accept or ignore the call.

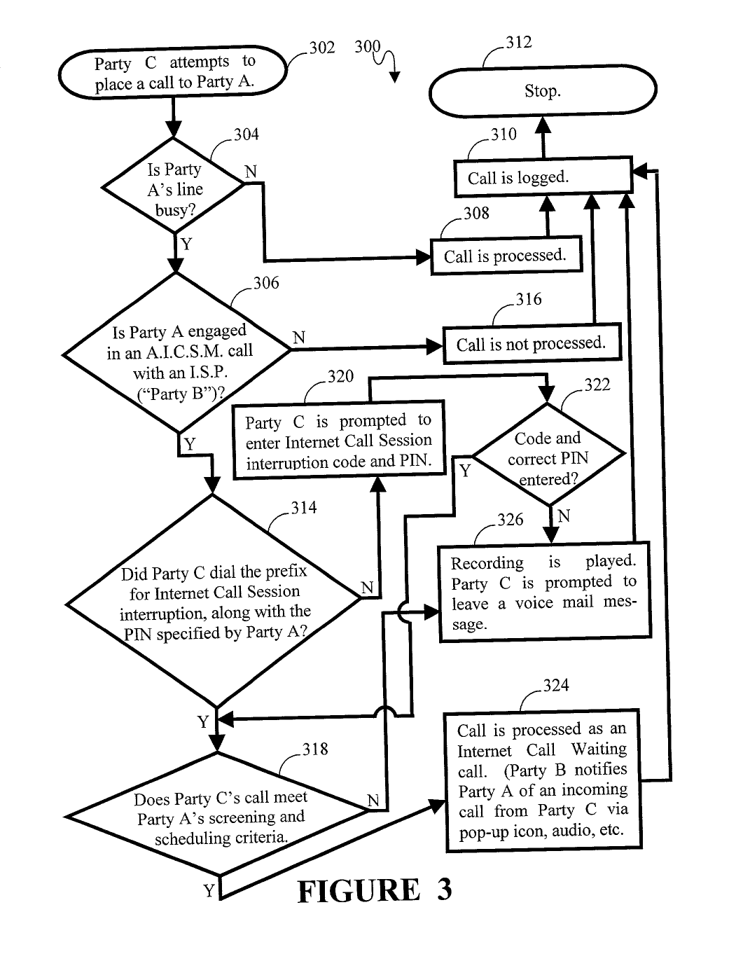

As will be described below with reference to the algorithm 300 of FIG. 3, the present invention disables the ICW function unless a calling party includes in a prefix code (or alternatively called an access code) before dialing the subscriber's telephone number, an alphanumeric triggering code, and a Personal Identification Number (PIN) given to the calling party by the subscriber. That is, the subscriber can limit which calling parties may enable ICW service by the careful and limited distribution of the PIN. Also as part of the present invention, the subscriber can establish screening and other criteria for allowing ICW calls, so that even if the calling party dials the correct PIN, ICW service will only be resumed if Caller ID restrictions, or time and day restrictions, and the like, are met.

Returning to FIG. 1, the subscriber can terminate (i.e., connect) voice telephone calls through the PSTN 130 via a voice path 128. When a calling party (represented by the icon 140) attempts to telephone the subscriber (represented by the icon 110) while the subscriber is using the present-inventive AICSM, a voice path 144 is established with the Local Switch 132 to provide the access code and the subscriber's telephone number.

An AICSM database (not shown) stores for each AICSM subscriber in the system, the subscriber's PIN, and any access criteria (or restrictions) established by the subscriber for calling parties to meet if they are to enable ICW service while the subscriber is connected to the Internet. The following is a non-exhaustive list of criteria that a subscriber can establish: calling line identities; caller identification numbers; dates; days of the week; and times.

The restrictions can be either positive or negative, and may be combined as desired. For example, the subscriber might decree that all telephone numbers will be accepted except those specified in the database. Or, for example, the subscriber might decree that only calling parties with telephone numbers matching those in the database will be accepted to enable the ICW service. The access criteria can be modified by the subscriber at any time by placing a call to a customer service number (automated or nonautomated) and following a menu if applicable, or via his/her computer by accessing the AICSM database directly via an Internet website.

Recall that the AICSM database can be implemented in the Local Switch 132 or in the Intelligent Network 292 in FIG. 2. It is also possible to implement the AICSM database in the ICW server (172 and 272).

The components in FIG. 2 have numbering analogous to the components in FIG. 1. That is, the second and third digits of the components in FIG. 2 correspond to components in FIG. 1 with the same second and third digits. The functionality of the analogous components is the same and will therefore not be further described.

Intelligent Networks (INs) are software and hardware hybrids that are used to automatically process telephone calls in a telephone system. A service control point (SCP) 290 in the IN 292 provides the logic that governs call handling, etc., and contains a database that stores useful information needed for various transactions. The IN also contains several switches for both receiving calls to the network and physically routing calls to destination numbers. Each switch contains a Service Switching Point (SSP) 232 for interfacing with calling parties and performing the actual call routing under the instruction of the SCP.

The SCP and SSP may be connected with a high-speed link utilizing, for example, the Intelligent Network Application Protocol (INAP), as approved by the European Telecommunications Standards Institute (ETSI) or International Telecommunication Unit (ITU). It will be appreciated by those skilled in the art that the SCP 290 can be implemented as a networked database, not limited to one geographic location.

2. Basic Advanced Internet Call Session Manager Call Flow

A general call flow of the present-inventive Advanced Internet Call Session Manager is described below, with reference to FIG. 3. The call flow is substantially the same whether or not the AICSM is implemented using an Intelligent Network.

The algorithm 300 representing the call flow of the present invention begins with Step 302 when a third party (“Party C”) attempts to place a call to an AICSM service subscriber (“Party A”). “Party B” is the designation given to an Internet Service Provider. In Step 304, the Switching Office or Local Service Switching Point (if an intelligent network is used) attempts to connect Party C's call to Party A. If the line is not busy, the call is processed normally in Step 308, and the algorithm finishes at Step 312. Otherwise, the algorithm advances to Step 306. If Party A's line is busy, the system determines whether Party A is an Advanced Internet Call Session Manager subscriber. If so, the system determines whether Party A is engaged in an Internet call session with the call session manager enabled.

If Party A is not engaged in an Internet Call session with the call session manager enabled, Party C receives a busy signal until he/she goes onhook (“hangs up”) to complete Step 316. While Party A is engaged in an Internet call session with the call session manager enabled, all calls received—whether connected or not, and whether or not the caller leaves a voice message—are logged for future review by the subscriber in Step 310.

For the generic algorithm 300, the system determines whether Party C has input a prefix (or access) code required to treat such a call as an Internet Call Waiting call (Step 314). An Internet Call Waiting call is one that is brought to the attention of the Internet subscriber while he/she is on-line. Upon being notified of the call, the subscriber can choose to have the call connected, or ignore it (enabling the calling party to leave a voice message, for example).

The prefix code can be an alphanumeric string input via a Dual Tone Multi-frequency (DTMF) keypad. The prefix code contains both trigger digits for triggering the treatment of the call as an Internet Call Waiting call (Step 324, provided the conditions in Step 318 are met), and a Personal Identification Number (PIN) established by the subscriber and stored in memory. This allows the subscriber to limit access to his/her Internet Call Waiting service to those whom he/she has given the PIN (e.g., family members, close friends, and important specified institutions such as schools). An example of the prefix code trigger digits is “*55.” In practice, Party C would first dial the prefix code followed by Party A's telephone number, such as “*55xxxnnnnnnn,” where “xxx” represents the PIN, and “nnnnnnn” represents Party A's telephone number.

If Party C has not dialed Party A's PIN subsequent to dialing the prefix code, the system prompts Party C to choose from menu options, including activating the Internet Call Waiting manager. If Party C chooses to activate the Internet Call Waiting Manager (recall that this notifies Party A that Party C is attempting to connect a call), he/she must then enter the correct PIN (Step 320). If the correct PIN is entered, the algorithm advances to Step 324 to process the call as an Internet Call Waiting call. If the correct PIN is not entered (or if no PIN is entered), the algorithm advances to Step 326, as per Step 322.

Step 326 gives Party C the option of leaving a voice message.

Regarding Steps 320 and 322, an audio message might say the following: “The customer you are trying to reach is currently connected to the Internet. If you have been authorized by the customer to interrupt his or her Internet connections, please press ‘*55’ followed by the Personal Identification Number you were given by the customer.”

After Step 314 or Step 322, and for the case where Party C has entered the correct PIN, the system determines whether other criteria established by the subscriber have been met (Step 318). For example, the subscriber can determine from which telephone numbers, area codes, country codes, local exchanges, etc. to accept telephone calls while on the Internet. Likewise, the subscriber can specify telephone numbers, area codes, country codes, local exchanges, etc. from which calls will not be accepted. The subscriber can also establish temporal information regarding when a call will or will not be ignored (although the calling party may have the opportunity to leave voice mail).

If the subscriber's screening and scheduling criteria are met, the call is processed as an Internet Call Waiting call in Step 324. For the case where the screening and scheduling criteria are not met, a typical outgoing message (Step 326) might state: “I'm sorry. This call cannot be completed at this time. Please feel free to leave up to a one minute message when you hear the tone, and then hang up. If you do not wish to leave a message, please hang up now”

Variations and modifications of the present invention are possible, given the above description. However, all variations and modifications which are obvious to those skilled in the art to which the present invention pertains are considered to be within the scope of the protection granted by this Letters Patent.

For example, if calling parties attempt to place calls to an Advanced Internet Call Session Manager subscriber currently engaged in an Internet call session, and the calling parties do not know the PIN required by the subscriber, the calling parties can, at the option of the subscriber, and for a fee charged to the calling party by the system operator, still connect the call to be treated by as an Internet Call Waiting call. This gives the system the flexibility to allow general calling parties to place emergency or urgent calls while the subscriber is otherwise engaged in an Internet call session.

What is claimed is:

1. In a Public Switched Telephone Network (PSTN), the method comprising the steps of:
a) connecting a subscriber's telephone line to an Internet Service Provider (ISP);
b) while said subscriber's telephone line is connected to said ISP, disabling an Internet Call Waiting (ICW) server;
c) when a telephone call is placed to said subscriber's telephone line, ascertaining whether a calling party has input a subscriber-defined access code;
d) connecting said calling party to said ICW server and enabling it, if said calling party has input said access code;
e) not connecting said calling party to said ICW server if said calling party has not input said access code; and
f) via said enabled ICW server, displaying caller identification information to said subscriber when a call has been connected to said ICW server to allow said subscriber to cause said call to be connected, or ignore the call.

2. The method in claim 1 wherein said access code comprises a security code comprising a plurality of alphanumeric characters in a specific order as established by said subscriber.

3. The method in claim 1 wherein said access code further comprises an ICW trigger code adapted to trigger the operation of said ICW server, said trigger code being established by the operator of said PSTN.

4. The method in claim 1 further comprising the step of:
g) performing step d only if the calling party number is permissible according to subscriber-defined screening criteria.

5. The method in claim 1 further comprising the step of:
h) performing step d only if current temporal aspects are permissible according to subscriber-defined temporal criteria.

6. The method in claim 1 further comprising the step of:
i) performing step d only if the calling party number is permissible according to subscriber-defined screening criteria, and only if current temporal aspects are permissible according to subscriber-defined temporal criteria.

7. The method in claim 1, wherein said calling party inputs said access code as part of a prefix to said subscriber's telephone number when said calling party places a call to said subscriber's telephone line.

8. The method in claim 1, further comprising the step of:
j) prompting said calling party to input said access code.

9. The method in claim 1, further comprising the step of:
maintaining a subscriber-reviewable log of a'all telephone calls attempted to be made to the subscriber during a subscriber's Internet Call session.

10. The method in claim 1, further comprising the steps of:
maintaning a subscriber-reviewable log of all telephone calls attempted to be made to the subscriber during a subscriber's Internet Call session; and
receiving subscriber-retrievable voice mail from calls that were not completed to the subscriber.

11. The method in claim 1, wherein steps a) through e) are carried out via a local switch.

12. The method in claim 1, wherein steps a) through e) are carried out via an Intelligent Network.

13. The method in claim 2, wherein steps a) through e) are carried out via an Intelligent Network.

14. The method in claim 3, wherein steps a) through e) are carried out via an Intelligent Network.

15. The method in claim 4, wherein steps a) through e) and g) are carried out via an Intelligent Network.

16. The method in claim 5, wherein steps a) through e) and h) are carried out via an Intelligent Network.

17. The method in claim 6, wherein steps a) through e) and i) are carried out via an Intelligent Network.

18. The method in claim 7, wherein steps a) through e) are carried out via an Intelligent Network.

19. The method in claim 8, wherein steps a) through e) are carried out via an Intelligent Network.

20. The method in claim 9, wherein steps a) through e) are carried out via an Intelligent Network.

21. The method in claim 10, wherein steps a) through e) are carried out via an Intelligent Network.
